(19) United States
(12) Patent Application Publication
(10) Pub. No.: US 2005/0278464 A1
(43) Pub. Date: Dec. 15, 2005

(54) Multiple state configuration method

(76) Inventor: George R. Claseman, Campbell, CA (US)

Correspondence Address: PATENT LAW GROUP LLP, 2635 NORTH FIRST STREET, SUITE 223, SAN JOSE, CA, 95134, US

(21) Appl. No.: 10/846,724

(22) Filed: May 13, 2004

(51) Int. Cl. G06F 15/177; G06F 13/10

(52) U.S. Cl. 710/14; 713/1; 713/100

(57) ABSTRACT

A method for assigning a value to a fixed parameter in an electrical device includes providing multiple programming pins where the number of programming pins corresponds to the number of states of the fixed parameter and each programming pin provides a signaling pattern, connecting a first input terminal of the electrical device to one of the programming pins, determining the signaling pattern received at the first input terminal, and selecting a state for the fixed parameter based on the signaling pattern detected at the first input terminal. The signaling patterns provided by the multiple programming pins can be different signaling patterns or the same signaling pattern can be used for multiple programming pins by asserting the programming pins at different times. A large number of fixed parameters can be programmed by forming an interconnect matrix connecting the programming pins to the input terminals corresponding to the fixed parameters.

### FIELD OF THE INVENTION

The invention relates to a method for fixed parameter assignment in an integrated circuit and, in particular, to a method for fixed parameter assignment using a reduced number of input/output pins.

### DESCRIPTION OF THE RELATED ART

Electrical devices or integrated circuits providing application specific functions often require assignment of values for certain fixed parameters on the devices upon start-up in order to operate in the application in which the devices are incorporated. Fixed parameter assignment is often used for address assignments, selecting a mode of operation, and selecting other fixed operating personality elements of the device. Examples of devices where mode selection is used are Ethernet devices using a large number of addressing pins for programming, hardware devices including one or more fixed operation modes, and digital and analog devices using SM bus (system management bus) addressing as the control and status interface. These devices are often designed with multiple operational personalities whereby one or a group of operational personalities are selected when the device is installed for use. The selected personalities are usually permanent to be used for the life-time of the device in the application.

In many integrated circuits, the desired mode or function is usually selected by programming one or more fixed parameters through one or more input/output (I/O) pins of the integrated circuit. A specific address, mode or personality is selected by assigning a specific value to a parameter in the integrated circuit in which the parameter is linked to the desired address, operation mode or personality. Conventional fixed parameter assignment is typically implemented using a binary strap option. That is, a pin is connected either to a logical high voltage or a logical low voltage to select one of two possible states for a predefined parameter.

When a parameter is linked to multiple choices or is associated with long fields, multiple I/O pins will be required to implement fixed parameter value assignment when the binary strap method is used. Excessive pin count is undesirable as it results in increased material and manufacturing cost. Alternate methods exist for assigning values to fixed parameters on an electrical device, but generally these alternate methods require an additional external storage device.

It is desirable to provide a method for fixed parameter assignment using minimum I/O pins.

### SUMMARY OF THE INVENTION

According to one embodiment of the present invention, a method for assigning a value to a fixed parameter in an electrical device where the fixed parameter has a multiple number of states includes providing multiple programming pins where the number of programming pins corresponds to the number of states of the fixed parameter and each programming pin provides a signaling pattern, connecting a first input terminal of the electrical device to one of the programming pins, determining the signaling pattern received at the first input terminal, and selecting a state for the fixed parameter based on the signaling pattern detected at the first input terminal.

In one embodiment, the signaling patterns provided by the multiple programming pins are selected from the group of fixed voltage levels and pulses of varying duty cycle. For example, the signaling pattern can be a positive power supply voltage of the electrical device or a negative power supply voltage of the electrical device.

In another embodiment, the signaling patterns provided by the a first group of programming pins in the multiple programming pins are the same signaling pattern, denoted as the first signaling pattern. The method further includes asserting the first signaling pattern on each programming pin of the first group of programming pins at different times, at each time the first signaling pattern is asserted on a programming pin in the first group of programming pins, detecting the presence of the first signaling pattern at the first input terminal, and selecting a state for the fixed parameter based on the programming pin being asserted when the first signaling pattern is detected at the first input terminal

A large number of fixed parameters can be programmed by forming an interconnect matrix connecting the programming pins to the input terminals corresponding to the fixed parameters.

The present invention is better understood upon consideration of the detailed description below and the accompanying drawings.

### BRIEF DESCRIPTION OF THE DRAWINGS

FIG. 1 is a schematic diagram of an electrical device employing the fixed parameter value assignment method according to one embodiment of the present invention.

FIG. 2 is a schematic diagram of an electrical device configured to program a first parameter and a second parameter using the fixed parameter value assignment method of the present invention.

### DETAILED DESCRIPTION OF THE PREFERRED EMBODIMENTS

In accordance with the principles of the present invention, a method for fixed parameter assignment in an electrical device uses signal sources from the device itself for programming the fixed parameters. In this manner, user configurations of an electrical device can be realized without the use of external components. Furthermore, the fixed parameter value assignment method of the present invention minimizes the number of input/output pins that are required to program multiple fixed parameters or fixed parameters including long programming fields.

More specifically, the fixed parameter value assignment method of the present invention uses output signals from the electrical device itself to program fixed parameter values for the electrical device. Using the method of the present invention, a complex state can be programmed by interconnecting the desired state output signals to the desired input pins associated with the fixed parameters. A matrix is thus formed connecting a selected number of output signals (or output states) to one or more input pins associated with fixed parameters. In this manner, any number of fixed parameters can be programmed using a selected group of output signals and no external components are needed for programming fixed parameters. Furthermore, each output state can be used to program multiple fixed parameters.

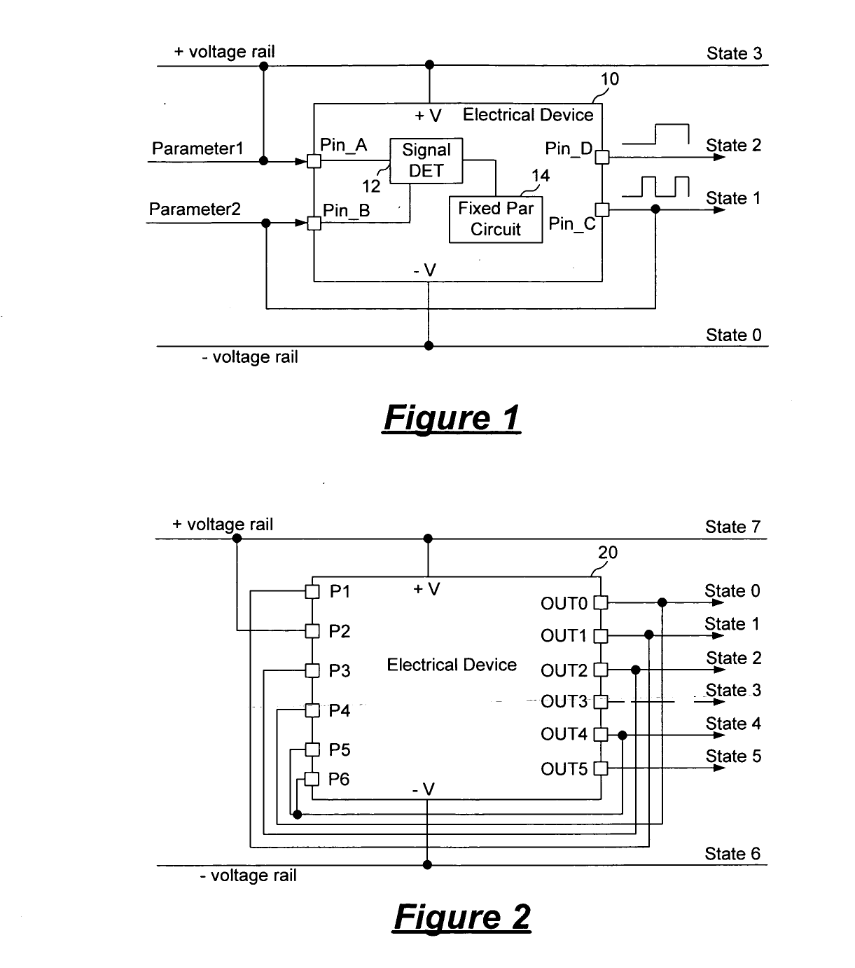

FIG. 1 is a schematic diagram of an electrical device employing the fixed parameter value assignment method according to one embodiment of the present invention. Referring to FIG. 1, an electrical device 10 is incorporated in a system for performing an application specific function. Electrical device 10 includes input/output terminals (not shown) for receiving incoming signals from and providing output signals to other components in the system. Electrical device 10 can be an integrated circuit in which case the input/output terminals are typically referred to as input/output (I/O) pins. When electrical device 10 is incorporated in a system for normal operation, the device is coupled to a positive voltage rail providing a positive power supply voltage (+V) and a negative voltage rail providing a negative power supply voltage (−V). Typically, the positive power supply voltage is referred to as the Vdd voltage and can be between 3.3 and 5 volts while the negative power supply voltage is referred to as the Vss voltage and is usually the ground voltage (0 volts).

Electrical device 10 includes an I/O pin PIN_A and an I/O pin PIN_B designated for fixed parameter assignments. I/O pins designated for fixed parameter assignments, such as PIN_A and PIN_B, will be referred to as parameter pins in the present description. PIN_A is associated with a first fixed parameter (parameter1) and receives an input signal value for programming the parameter. PIN_B is associated with a second fixed parameter (parameter2) and receives an input signal value for programming the parameter. PIN_A and PIN_B are coupled to a signal detection circuit 12 for detecting the state of the input signal received on the respective pin. The detected input signal can be provided to a fixed parameter circuit 14 to select a desired value or a desired state for the fixed parameter associated with PIN_A and PIN_B.

Electrical device 10 also includes an I/O pin PIN_C providing an output signal having a first signal state (State 1) and an I/O pin PIN_D providing an output signal having a second signal state (State 2). I/O pins PIN_C and PIN_D can be pins dedicated for programming use or multi-function I/O pins. In the following description, I/O pins on electrical device 10 providing output states for programming fixed parameters will be referred to as programming pins. The output states of the programming pins are represented in the form of signal patterns. The signal patterns provided by the programming I/O pins can assume any signaling pattern. The particular signaling pattern of the output signals is not critical to the practice of the present invention as the signals are generated from the electrical device itself. For instance, the output signals can be signal pulses or different voltage levels or different signaling method. The signal pulses can be of varying duty cycle to provide the desired signal differentiation. In the present illustration, PIN_C provides an output signal having double the duty cycle of the output signal of PIN_D.

Furthermore, the signaling patterns for the programming pins can be the same or can be different from each other. When a unique signaling pattern is used for each programming pin, the signaling pattern itself can be used to detect the connection of the parameter pins. Alternately, the signaling pattern for all or a group of the programming pins can be the same. When the same signaling pattern is used for multiple programming pins, the connection of the parameter pins can be determined by asserting the programming pins with the same signaling pattern at different times while observing the parameter pins. That is, if PIN_C and PIN_D has the same signaling pattern, the parameter pin connection can be detected by asserting one programming pin first (such as State 1 of PIN_C) while observing parameter pins PIN_A and PIN_B to detect the presence of a signal on the parameter pins. Then, the other programming pin (such as State 2 of PIN_D) can be asserted while observing parameter pins PIN_A and PIN_B to detect the presence of a signal on the parameter pins. In this manner, programming pins having the same signaling pattern are asserted at different times to effectuate detection of the parameter pin connections.

Furthermore, the power supply voltages used by electrical device 10 can be used as signal states for programming fixed parameter as well. For example, the Vdd pin and the Vss pin of electrical device 10 can be used as programming pins providing two additional programming states. Thus, the positive power supply voltage (+V) and the negative power supply voltage (−V) of electrical device 10 are used to provide two additional programming states so that a total of four programming states are available for each parameter assignment. In FIG. 1, the negative power supply voltage (−V) is denoted as State 0 and the positive power supply voltage (+V) is denoted as State 3.

In accordance with the method of the present invention, a parameter, such as parameter1, of electrical device 10 is programmed by connecting the I/O pin associated with the parameter to one of the output states. For example, PIN_A is connected to the positive power supply voltage to program parameter1 to State 3 while PIN_B is connected to PIN_C to program parameter2 to State 1. Signal detection circuit 12 operates to determine the respective signaling state of the input signal on PIN_A and PIN_B and fixed parameter circuit 14 selects the desired value for the parameters based on the signaling pattern. In this manner, each of the two fixed parameters of electrical device 10 can be programmed to one of four states. The selected state of the fixed parameter can be used to select one of several operation modes on device 10 or used to assign an address value for an address field in device 10.

To implement the fixed parameter value assignment method of the present invention for an electrical device, a specific number of output states or programming pins needs to be provided. The number of output states required can be determined as followed. First, the total number of states that needs programming is determined. The number of programming states can equate to an equal number of binary parameter pins. To reduce the number of parameter pins, the programming states can be grouped into parameter pins with multiple programming states. Then, the maximum number of states on any of the parameter pins determines the number of output states required to implement the method of the present invention. A corresponding number of programming pins are then assigned to provide the desired number of output states. The power supply voltages (Vdd and Vss) can account for two of the total number of output states. Thus, the minimum number of additional output or I/O pins required to implement the method of the present invention is the maximum number of required output states on the parameter pins minus two.

The fixed parameter value assignment method of the present invention is particularly useful when there are a large number of parameters to set up on an electrical device. For instance, only two programming pins are required to program four states for each parameter. The power supply pins provide the additional two states. When a parameter is defined by more states, the number of output pins required for providing output states is at least reduced by two through the use of the power supply pins. An interconnect matrix is formed connecting the output states provided by the programming pins and the power supply pins to the parameter pins. A single output state can be connected to multiple parameter pins for programming multiple pins of the electrical device. By forming an interconnecting matrix of programming pins and parameter pins, the desired operational mode or address values for an electrical device is permanently programmed on the electrical device.

FIG. 2 is a schematic diagram of an electrical device employing the fixed parameter value assignment method for programming multiple fixed parameters. In the embodiment shown in FIG. 2, an electrical device 20 includes six parameters requiring programming. The six parameters are coupled to parameter pins P1 to P6 as shown in FIG. 2. The maximum number of states that needs to be programmed on any of the parameter pins is eight states. Thus, six programming pins OUT0 to OUT5 and the two power supply voltages are used to provide the eight programming states required. The eight programming states can have the same or different signaling patterns. FIG. 2 illustrates the formation of an interconnect matrix for connecting the eight available output states (State 0 to State 7) to the six parameter pins P1-P6 to effectuate programming of the six parameters. When a large number of parameters need to be programmed, the eight output states (State 0 to State 7) can be used to program all of the parameters such that a reduction in the pin count required for programming a large number of parameters is realized.

The fixed parameter value assignment method of the present invention can be applied in many applications for the purpose of configuring fixed parameters on an electrical device. When the fixed parameter consists of a large addressing field, groups of address bits can be assigned using a single parameter pin. When the programming pins provides eight programming states, each parameter pin can be used to program three address bits. In this manner, multiple parameter pins can be used for programming large addressing field.

The above detailed descriptions are provided to illustrate specific embodiments of the present invention and are not intended to be limiting. Numerous modifications and variations within the scope of the present invention are possible. For example, the programming pins can be implemented using only the I/O or output pins of the electrical device without using the power supply pins. In such a configuration, two additional pins are required to implement the fixed parameter value assignment method. When the number of parameters to be programmed is large, the two additional pins are usually not a significant factor. The present invention is defined by the appended claims.

1. A method for assigning a value to a fixed parameter in an electrical device, the fixed parameter having a plurality of states, the method comprising:
providing a plurality of programming pins, the number of programming pins corresponding to the plurality of states, each programming pin providing a signaling pattern;
connecting a first input terminal of the electrical device to one of the programming pins;
determining the signaling pattern received at the first input terminal; and
selecting a state for the fixed parameter based on the signaling pattern detected at the first input terminal.

2. The method of claim 1, wherein the plurality of states of the fixed parameter is associated with a plurality of operational modes of the electrical device.

3. The method of claim 1, wherein each of the plurality of states of the fixed parameter is associated with an address bit of a multi-bit addressing field.

4. The method of claim 1, wherein the signaling patterns provided by the plurality of programming pins are selected from the group of fixed voltage levels and pulses of varying duty cycle.

5. The method of claim 1, wherein the signaling patterns provided by a first group of programming pins in the plurality of programming pins comprise the same signaling pattern being a first signaling pattern, the method further comprising:
asserting the first signaling pattern on each programming pin of the first group of programming pins at different times;
at each time the first signaling pattern is asserted on a programming pin in the first group of programming pins, detecting the presence of the first signaling pattern at the first input terminal; and
selecting a state for the fixed parameter based on the programming pin being asserted when the first signaling pattern is detected at the first input terminal.

6. The method of claim 1, wherein a first signaling pattern provided by a first one of the plurality of programming pins comprises a positive power supply voltage of the electrical device.

7. The method of claim 1, wherein a first signaling pattern provided by a first one of the plurality of programming pins comprises a negative power supply voltage of the electrical device.

8. The method of claim 7, wherein the negative power supply voltage of the electrical device comprises the ground voltage of the electrical device.

9. A method for assigning a value to a fixed parameter in an electrical device, the fixed parameter having a plurality of states, the method comprising:
providing a plurality of programming pins, the number of programming pins corresponding to the plurality of states, a first group of programming pins providing the same signal pattern being a first signaling pattern;
connecting a first input terminal of the electrical device to one of the programming pins;
asserting the first signaling pattern on each programming pin of the first group of programming pins at different times;
at each time the first signaling pattern is asserted on a programming pin in the first group of programming pins, detecting the presence of the first signaling pattern at the first input terminal; and
selecting a state for the fixed parameter based on the programming pin being asserted when the first signaling pattern is detected at the first input terminal.

10. A method for assigning a value to a plurality of fixed parameters in an electrical device, each of the plurality of fixed parameters having a plurality of states, a first fixed parameter having a first number of states being the maximum number of states for the plurality of fixed parameters, the method comprising:
providing a plurality of programming pins, the number of programming pins corresponding to the first number of states, each programming pin providing a signaling pattern;
connecting each of a plurality of input terminals of the electrical device to one of the programming pins, each of the plurality of input terminals corresponding to a respective one of the plurality of fixed parameters;
determining the signaling pattern received at the plurality of input terminals; and
selecting a state for each of the plurality of fixed parameters based on the signaling pattern detected at each of the plurality of input terminals.

11. The method of claim 10, wherein the plurality of states of each of the plurality of fixed parameters is associated with a plurality of operational modes of the electrical device.

12. The method of claim 10, wherein each of the plurality of states of each of the plurality of fixed parameters is associated with an address bit of a multi-bit addressing field.

13. The method of claim 10, wherein the signaling patterns provided by the plurality of programming pins are selected from the group of fixed voltage levels and pulses of varying duty cycle.

14. The method of claim 10, wherein the signaling patterns provided by a first group of programming pins in the plurality of programming pins comprise the same signaling pattern being a first signaling pattern, the method further comprising:
asserting the first signaling pattern on each programming pin of the first group of programming pins at different times;
at each time the first signaling pattern is asserted on a programming pin in the first group of programming pins, detecting the presence of the first signaling pattern at each of the plurality of input terminals; and
selecting a state for each of the plurality of fixed parameter based on the programming pin being asserted when the first signaling pattern is detected at each of the plurality of input terminals.

15. The method of claim 10, wherein a first signaling pattern provided by a first one of the plurality of programming pins comprises a positive power supply voltage of the electrical device.

16. The method of claim 10, wherein a first signaling pattern provided by a first one of the plurality of programming pins comprises a negative power supply voltage of the electrical device.

17. The method of claim 16, wherein the negative power supply voltage of the electrical device comprises the ground voltage of the electrical device.

18. An electrical device including a fixed parameter to be programmed when the electrical device is in use, the electrical device comprising:
a plurality of programming pins, the number of programming pins corresponding to the programming states of the fixed parameter, each programming pin providing a signaling pattern;
an input terminal coupled to a respective one of the plurality of programming pins, the input terminal receiving an input signal having a signaling pattern provided by the respective one of the plurality of programming pins;
a signal detector coupled to the input terminal for receiving the input signal, the signal detector asserting an output signal indicative of the signaling pattern of the input signal; and
a fixed parameter circuit receiving the output signal of the signal detector and providing an output signal indicative of a selected programming state of the fixed parameter,
wherein the fixed parameter circuit selects a programming state for the fixed parameter based on the signaling pattern of the input signal.

19. The electrical device of claim 18, wherein the plurality of states of the fixed parameter are associated with a plurality of operational modes of the electrical device.

20. The electrical device of claim 18, wherein each of the plurality of states of the fixed parameter is associated with an address bit of a multi-bit addressing field.

21. The electrical device of claim 18, wherein the signaling patterns provided by the plurality of programming pins are selected from the group of fixed voltage levels and pulses of varying duty cycle.

22. The electrical device of claim 18, wherein the signaling patterns provided by a first group of programming pins in the plurality of programming pins comprise the same signaling pattern being a first signaling pattern, the first signaling pattern being asserted on each of the first group of programming pins at different times, and wherein at each time the first signaling pattern is asserted on a programming pin in the first group of programming pins, the signal detector detects the presence of the first signaling pattern at the input terminal and the fixed parameter circuit selects a state for the fixed parameter based on the programming pin being asserted when the first signaling pattern is detected at the input terminal.

23. The electrical device of claim 18, wherein a first signaling pattern provided by a first one of the plurality of programming pins comprises a positive power supply voltage of the electrical device.

24. The electrical device of claim 18, wherein a first signaling pattern provided by a first one of the plurality of programming pins comprises a negative power supply voltage of the electrical device.
